(19) United States
(12) Patent Application Publication
(10) Pub. No.: US 2019/0165662 A1
(43) Pub. Date: May 30, 2019

(54) LINEAR VIBRATION MOTOR

(71) Applicant: NIDEC COPAL CORPORATION, Tokyo (JP)

(72) Inventor: Masaya ENDO, Tokyo (JP)

(73) Assignee: NIDEC COPAL CORPORATION, Tokyo (JP)

(21) Appl. No.: 16/313,416

(22) PCT Filed: May 24, 2017
(86) PCT No.: PCT/JP2017/019416

§ 371 Date: Dec. 26, 2018

(30) Foreign Application Priority Data
Jul. 5, 2016 (JP) 2016-133224

(51) Int. Cl. H02K 33/16; B06B 1/04

(52) U.S. Cl. CPC H02K 33/16; B06B 1/045

(57) ABSTRACT

A thin linear vibration motor that suppresses the occurrence of operating noise. A linear vibration motor has a stationary element; a movable element that is supported elastically, so as to enable vibration along an axial direction, on the stationary element; and a driving portion causing the movable element to undergo reciprocating vibration along the axial direction, through the provision of a coil on the stationary element, the provision of a driving magnet on the movable element, and the application of an electric current to the coil while the driving magnet is attracted by magnetic material (supporting plate) that is provided on the stationary element side of the coil, wherein: the stationary element is provided with a stationary magnet that is magnetized in a direction that is perpendicular to the axial direction; and the movable element is provided with a movable magnet that opposes, while repelling, the stationary magnet.

### CROSS REFERENCE TO RELATED APPLICATIONS

This Application is the National Stage of International Application No. PCT/JP2017/019416 filed May 24, 2017, which in turn claims priority to Japanese Application Serial No. 2016-133224 filed Jul. 5, 2016. Both applications are incorporated herein in their entirety.

### FIELD OF TECHNOLOGY

The present invention relates to a linear vibration motor.

### BACKGROUND

Vibration motors (or “vibration actuators”) are built into mobile electronic devices, and are broadly used as devices to communicate to the user, through a vibration, that there is an incoming call, or that a signal, such as an alarm, has been generated, and have become indispensable devices in wearable devices, which are carried on the body of the user. Moreover, in recent years vibration motors have been of interest as devices by which to achieve haptics (skin-sensed feedback) in the human interfaces such as touch panels.

Among the various forms of vibration motors that are under development, there is interest in linear vibration motors that are able to generate relatively large vibrations through linear reciprocating vibrations of a movable element. A conventional linear motor is provided with a weight and a magnet on a movable element side, where an electric current is applied to a coil that is provided on the stator side to cause the Lorentz forces that act on the magnet to form a driving force, to cause the movable element, which is elastically supported along the direction of vibration, to undergo reciprocating vibrations in the axial direction (referencing Japanese Unexamined Patent Application Publication 2016-13554).

### SUMMARY OF THE INVENTION

Because the linear vibration motors are built into spaces within thin mobile electronic devices or wearable electronic devices, there is the need for a shape that is thin in the thickness direction, relative to the width direction that is perpendicular to the vibration direction. At this time, if the movable element were to rotate or pivot around the axis that is the direction of vibration, both side portions of the movable element in the width direction would strike the frame (case) that covers the movable element, resulting in a drawback in that this would produce a noise during vibration. In linear vibration motors that are to provide silent notification, to the operator, that a signal has occurred there is the need to suppress the production of operating noise insofar as is possible.

The linear vibration motor according to the present invention is to handle such a situation, and the object thereof is to provide a thin linear vibration motor that suppresses the production operating noise.

### Means for Solving the Problem

In order to solve such a problem, the linear vibration motor according to the present invention is provided with the following structures:

A linear vibration motor includes a stationary element; a movable element that is supported elastically, so as to enable vibration along an axial direction, on the stationary element; and a driving portion for causing the movable element to undergo reciprocating vibration along the axial direction, through the provision of a coil on the stationary element, the provision of a driving magnet on the movable element, and the application of an electric current to the coil while the driving magnet is attracted by magnetic material that is provided on the stationary element side of the coil, wherein: the stationary element is provided with a stationary magnet that is magnetized in a direction that is perpendicular to the axial direction; and the movable element is provided with a movable magnet that opposes, while repelling, the stationary magnet.

### BRIEF DESCRIPTION OF THE DRAWINGS

FIG. 1 is an exploded perspective diagram illustrating one example of a linear vibration motor according to an embodiment according to the present invention.

FIG. 2 is an assembly oblique view (without the case) of the example depicted in FIG. 1.

FIG. 3 is a front view of FIG. 2.

FIG. 4 is an explanatory diagram depicting the magnetization directions of the magnets (the driving magnet, the stationary magnet, and the movable magnet) equipped in the linear vibration motor according to the present invention.

FIG. 5 is an explanatory diagram illustrating a mobile electronic device in which is provided a linear vibration motor according to an embodiment according to the present invention.

### DETAILED DESCRIPTION

Embodiments according to the present invention will be explained below in reference to the drawings. In the descriptions below, identical reference symbols in the different drawings below indicate positions with identical functions, and redundant explanations in the various drawings are omitted as appropriate. In each figure, the arrow in the X direction indicates the direction of vibration of the movable element, the arrow in the Y direction indicates the width direction of the movable element, and the arrow in the Z direction indicates the thickness direction of the movable element.

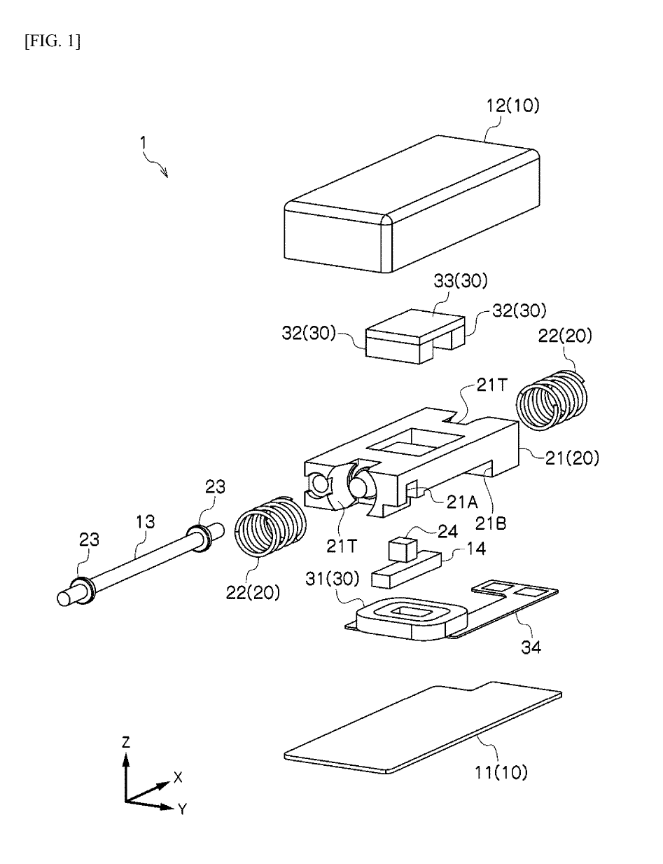

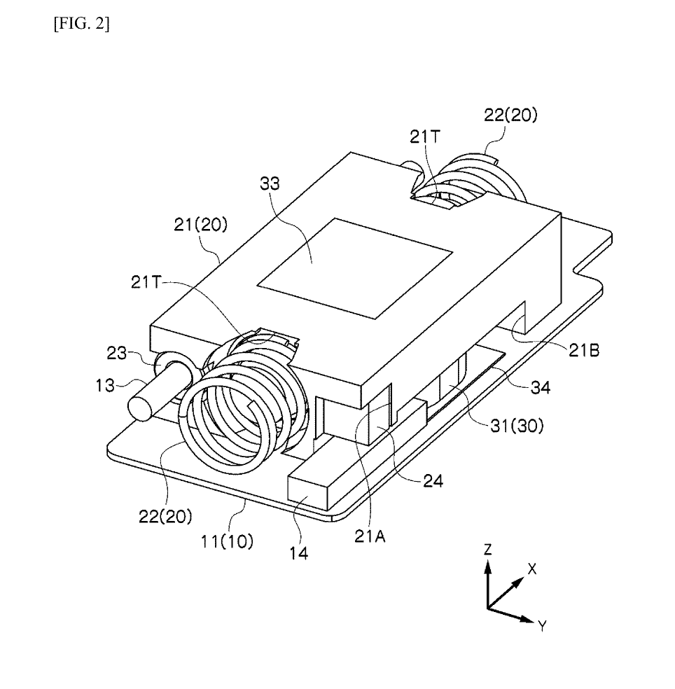

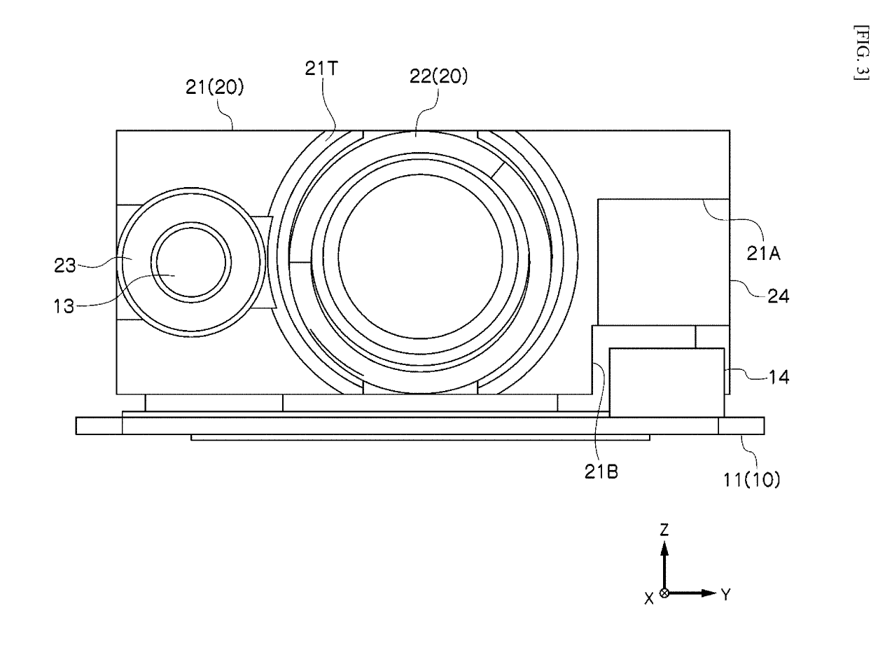

FIG. 1 through FIG. 3 illustrate one example of a linear vibration motor according to an embodiment according to the present invention. The linear vibration motor 1 comprises a stationary element 10, a movable element 20, and a driving portion 30. The stationary element 10, in the example in the figure, is equipped with a supporting plate 11 and a case 12. The movable element 20 is borne slidably in relation to the stationary element 10, and is supported elastically so as to enable vibration along the axial direction (the X direction in the figure). The movable element 20, in the example in the figure, is equipped with a weight portion 21, a pair of coil springs 22 that extend and retract along the X direction in the figure, where a spring supporting portion 21T, for supporting one end side of the coil spring 22, is provided on the weight portion 21, and a yoke 33 and driving magnets 32 of the driving portion 30, described below, are attached.

The driving portion 30 comprises a coil 31 that is attached to the stationary element 10 (a supporting plate 11), and driving magnets 32 that are provided on the movable element 20 (the weight portion 21). In this driving portion 30, a coil 31 is arranged in a magnetic circuit that is formed from a pair of magnets 32, a yoke 33 on the movable element 20 side for coupling with this pair of driving magnets 32, and a supporting plate 11, made from a magnetic material, that serves as a yoke on the stationary element 10 side, where the application of a driving signal to the coil 31 through a flexible circuit board 34 causes the movable element 20 to vibrate, reciprocating along the axial direction (the X direction in the figure) while the driving magnets 32 are attracted by the supporting plate 11 of the magnetic material. The driving signal that is applied to the coil 31 is a pulse signal or an alternating current signal, or the like, of the resonant frequency (the natural frequency) that is determined by the spring constant of the coil springs 22 and the mass of the movable element 20 (the weight portion 21). While, in the explanation above, the supporting plate 11 was of a magnetic material to serve as a yoke on the stationary element 10 side, instead the supporting plate 11 may be a non-magnetic body, and a separate yoke may be provided between the supporting plate 11 and the coil 31, so that the driving magnets 32 will be attracted by this yoke.

The linear vibration motor 1 can have a guide shaft 13. The guide shaft 13 is provided extending in the axial direction (the X direction in the figure), and the movable element 20 is borne so as to enable sliding along the guide shaft 13. In the example in the figure, the guide shaft 13 is secured on both ends to the stationary element 10 (the case 12), and a bearing 23 is provided so as to bear the guide shaft 13 slidably on the movable element 20 side; however, the guide shaft 13 may be provided instead on the movable element 20 side, and the bearing may be provided so as to support the guide shaft 13 slidably on the stationary element 10 side.

Moreover, in this linear motor 1, the stationary element 10 side is equipped with a stationary magnet 14, and the movable element 20 side is equipped with a movable magnet 24. Here the stationary magnet 14 is magnetized in a direction (the Z direction in the figure) that is perpendicular to the axial direction (the X direction in the figure), and is secured over the supporting plate 11, which is of a magnetic material. Moreover, the stationary magnet 14 extends along the axial direction (the X direction in the figure. In contrast, the movable magnet 24 is magnetized in the opposite direction of that of the stationary magnet 14. Through this, the driving magnets 32 are attracted to the supporting plate 11 side, which is a magnetic material, but the movable magnet 24 is in opposition, repelling the stationary magnet 14. Because of this, the movable magnet 24 that is secured to the movable element 20 is subject to the repelling magnetic force from the stationary magnet 14, so as to vibrate in a non-contacting state.

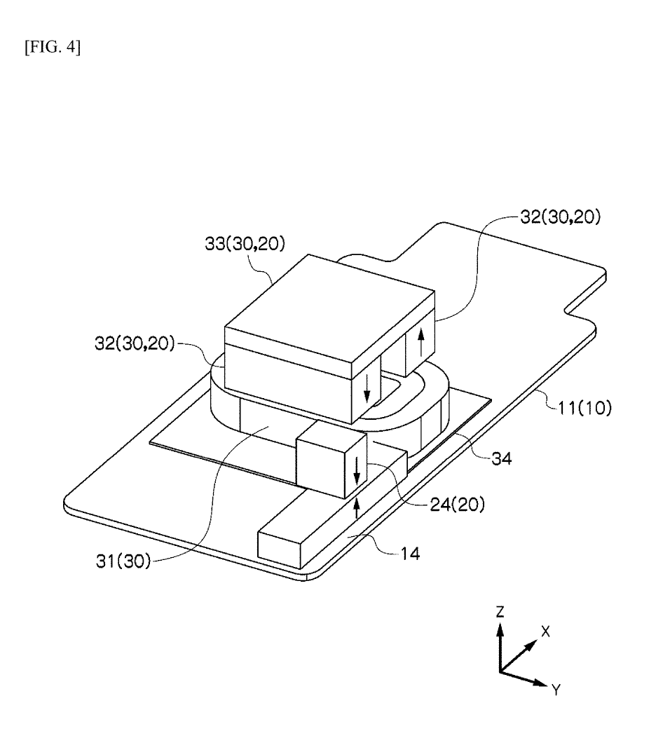

FIG. 4 depicts the magnetization directions of the driving magnets 32 of the driving portion 30, the stationary magnet 14, and the movable magnet 24. The pair of driving magnets 32 are magnetized, in mutually opposing directions, along the Z direction in the figure, where the linear part, extending in the Y direction in the figure, of the coil 31 that is disposed within the magnetic circuit that is structured from the pair of driving magnets 32, the yoke 33, and the supporting plate 11 of the magnetic material has magnetic flux pass therethrough in the Z direction in the figure, and thus a driving force in the X direction in the figure is applied to the driving magnets 32.

In contrast, the stationary magnet 14 and the movable magnet 24 are magnetized, in mutually opposing directions, along the direction of the Z direction in the figure. The movable magnet 24 that is provided on the movable element 20 is disposed so as to face the stationary magnet 14 that extends along the X direction in the figure, and, similarly, the driving magnets 32 that are disposed on the movable element 20 are disposed in positions that do not interfere with the stationary magnet 14. Note that, in the example in the figure, while the stationary magnet 14 is provided extending in the X direction in the figure, and the movable magnet 24 opposes the stationary magnet 14, instead, conversely, the movable magnet 24 may extend in the X direction in the figure, and the stationary magnet 14 may oppose the movable magnet 24.

Given such a linear vibration motor 1, when the movable element 20 vibrates reciprocating along the axial direction, the movable magnet 24 that is provided on the movable element 20 vibrates while maintaining a constant spacing, in what is always a non-contacting state, over the stationary magnet 14 that is provided on the stationary element 10. Through this, the movable element 20 is not only able to vibrate while suppressing the operating noise extremely, but is also able to vibrate in the axial direction in a steady state wherein a rotation or pivoting around the axis is suppressed. This enables suppression of the operating noise, eliminating the drawback of the noise that would be produced through the movable element 20 contacting the supporting plate 11 or the case 12.

In the example depicted in FIG. 1 through FIG. 3, the movable element 20 is of a thin shape wherein the dimension in the thickness direction thereof (the Z direction in the figure) is less than the dimension in that the width direction (the Y direction in the figure). Additionally, a bearing 23 is provided for bearing the guide shaft 13, on one end, in the Y direction in the figure, of the movable element 20, and a movable magnet 24 is provided on the other end side, in the Y direction in the figure, of the movable element 20. Through this, the movable element 20 is able to vibrate along the axial direction while being supported flat by the movable magnet 24 that is held by the guide shaft 13 and over the stationary magnet 14, making it possible to achieve a stabilized vibration with parallel movement along the X-Y plane.

The stationary magnet 14 that is secured to the stationary element 10 side has a length that is at least equal to the amplitude of the movable element 20 along the axial direction. A recessed portion 21A, recessed in the Z direction in the figure (the thickness direction of the movable element 20) is provided in the weight portion 21 of the movable element 20, and the movable magnet 24 is provided in this recessed portion 21A. Moreover, a recessed portion 21B, which is recessed in the Z direction in the figure, and which is provided extending in the X direction in the figure, is provided in the weight portion 21, so that the stationary magnet 14 will be located within the recessed portion 21B when the movable element 20 vibrates. The provision of the recessed portions 21A and 21B in this way in the weight portion 21 enables the stationary magnet 14 and the movable magnet 24 to be provided while still suppressing the thickness (the height in the Z direction in the figure) of the linear vibration motor 1.

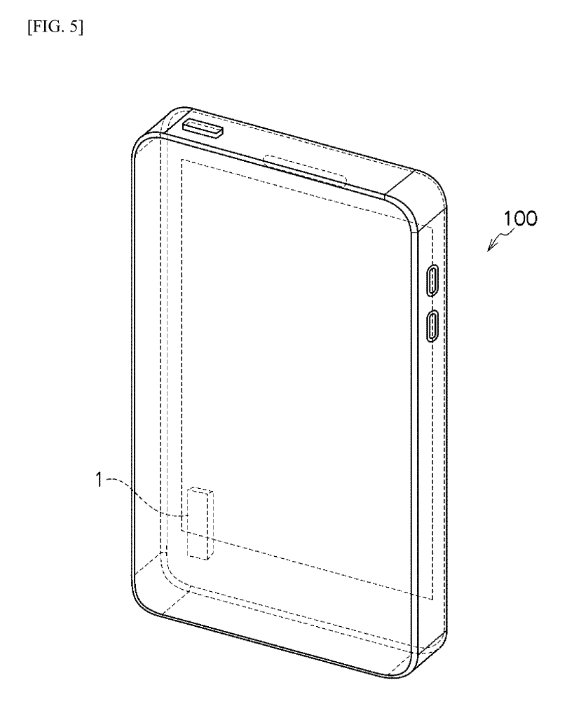

FIG. 5 illustrates a mobile information terminal 100 as one example of a mobile electronic device equipped with a linear vibration motor 1 according to an embodiment according to the present invention. The mobile information terminal 100, provided with the linear vibration motor 1 is able to convey silently, to a user, an incoming call in a communication function, an alarm function, or the like. Moreover, this makes it possible to produce a mobile information terminal 100 that facilitates superior mobility and design quality through making the linear vibration motor 1 thinner and smaller. Furthermore, because the linear vibration motor 1 is of a compact shape wherein the various components are contained within a case 12 of a rectangular shape wherein the thickness is suppressed, it can be mounted, with excellent space efficiency, within a thinner mobile information terminal 100.

While embodiments according to the present invention were described in detail above, referencing the drawings, the specific structures thereof are not limited to these embodiments, but rather design variations within a range that does not deviate from the spirit and intent of the present invention are also included in the present invention. Moreover, insofar as there are no particular contradictions or problems in purposes or structures, or the like, the technologies of the various embodiments described above may be used together in combination.

1. A linear vibration motor comprising:
a stationary element;
a movable element that is supported elastically, so as to enable vibration along an axial direction, on the stationary element; and
a driving portion causing the movable element to undergo reciprocating vibration along the axial direction, through the provision of a coil on the stationary element, the provision of a driving magnet on the movable element, and the application of an electric current to the coil while the driving magnet is attracted by magnetic material that is provided on the stationary element side of the coil, wherein:
the stationary element is provided with a stationary magnet that is magnetized in a direction that is perpendicular to the axial direction; and
the movable element is provided with a movable magnet that opposes, while repelling, the stationary magnet.

2. The linear vibration motor as set forth in claim 1, wherein:
the stationary magnet or the movable magnet is provided extending along the axial direction.

3. The linear vibration motor as set forth in claim 1, wherein:
the movable element is borne, in the axial direction of the movable element, on one end side in a direction that is perpendicular to the axial direction in the movable element, so as to be able to slide on a guide shaft that is disposed along the axial direction, and the movable magnet is equipped on the other end side, in a direction that is perpendicular to the axial direction, in the movable element.

4. The linear vibration motor as set forth in claim 1, wherein:
in the movable element, a dimension in a thickness direction, which is perpendicular to the axial direction, is less than a dimension in a width direction, which is perpendicular to the axial direction, and the movable magnet is magnetized in the thickness direction.

5. The linear vibration motor as set forth in claim 1, wherein:
the stationary element comprises a supporting plate of a magnetic material, and the coil and the stationary magnet are provided over the supporting plate.

6. The mobile electronic device comprising a linear vibration motor as set forth in claim 1.
